(19) United States
(12) Patent Application Publication
(10) Pub. No.: US 2023/0407912 A1
(43) Pub. Date: Dec. 21, 2023

(54) DEVICE FOR SUPPORTING AN INTERMEDIATE SHAFT OF A TRANSMISSION

(71) Applicant: Vibracoustic SE, Darmstadt (DE)

(72) Inventors: Markus Dürre, Neuenburg am Rhein (DE); Friedrich Back, Müllheim (DE); Jörg Hess, Kandern (DE); Hagen Kessler, Müllheim (DE)

(21) Appl. No.: 18/036,752

(22) PCT Filed: Nov. 1, 2021
(86) PCT No.: PCT/EP2021/080267

§ 371 Date: May 12, 2023

(30) Foreign Application Priority Data
Nov. 13, 2020 (DE) 10 2020 130 067.0

(51) Int. Cl. F16C 27/02; F16C 27/06; F16H 57/021; F16H 57/028

(52) U.S. Cl. CPC F16C 27/02; F16C 27/063; F16H 57/021; F16H 57/028; F16C 2326/06; F16C 2361/31

(57) ABSTRACT

The invention relates to an apparatus for supporting an intermediate shaft, such as an intermediate shaft of a gearbox. In an embodiment, the apparatus comprises at least one bearing part for supporting an intermediate shaft and having an outer surface with at least a section that is circumferential; at least one carrier part having an inner surface extending about the outer surface at a first distance from the bearing part; and at least one molded part for decoupling the carrier part from the bearing part, the molded part disposed between the inner surface and the outer surface, and the molded part being frictionally engaged with the inner surface and the outer surface. The invention provides a device that, among other things, can be manufactured cost-effectively.

### CROSS-REFERENCE TO RELATED APPLICATIONS

This application is a National Stage Patent Application of International Patent Application No. PCT/EP2021/080267, filed Nov. 1, 2021, which claims the benefit of German Application Serial No. 10 2020 130 067.0, filed Nov. 13, 2020, the contents of each are incorporated by reference in their entireties.

### TECHNICAL FIELD

The invention relates to a device for supporting an intermediate shaft, such as an intermediate shaft of a gearbox.

### BACKGROUND

The force of an internal combustion engine is transmitted to the wheels of a vehicle by a gearbox. For this purpose, the rotational axis of the engine can be installed in the vehicle in the direction of travel or transversely to the direction of travel. If the engine is installed transversely to the direction of travel of the vehicle, the output of the gearbox is usually not arranged centrally in the vehicle. If this off-center gearbox output is directly connected to the wheels by torsionally soft sideshafts, so called twisting occurs in which the sideshafts are subject to varying degrees of torsion, which has a very negative effect on driving characteristics. A “torsionally stiff” intermediate shaft is usually used to prevent this to make the length of the torsionally soft sideshafts approximately equal. Twisting can be virtually eliminated by the intermediate shaft. The intermediate shaft requires support at the connection between the intermediate shaft and the sideshaft. This intermediate shaft bearing is decoupled from the vehicle by an elastomer track to compensate for tolerances and for improved acoustics.

For this purpose, it is known to provide a bearing for an intermediate shaft, in which a bearing carrier for connection to the vehicle has a central receptacle for the intermediate shaft. The receptacle comprises an elastomer track which is produced by a chemical bond, for example by means of an adhesion promoter, during vulcanization of the elastomer under high pressure and high temperature. Further inside, a rolling bearing or an inner receptacle for a rolling bearing is connected to the track. The vulcanization by chemical bonding and adhesion promoters causes high costs, whereby the surfaces involved in the adhesion are specially designed for this purpose, so that the bonding is established successfully and sustainably.

### SUMMARY

Embodiments of the disclosure can provide a device that can be manufactured cost-effectively.

Aspects and features of embodiments of the disclosure are provided herein.

In a device for supporting an intermediate shaft, such as an intermediate shaft of a gearbox, the device may comprise: at least one bearing part for supporting an intermediate shaft and having an outer surface with at least a circumferential section; at least one carrier part extending about the outer surface with an inner surface at a first distance from the bearing part; and at least one molded part for decoupling the carrier part from the bearing part, the molded part being disposed between the inner surface and the outer surface. In embodiments of the invention, the molded part is frictionally connected to the inner surface and the outer surface.

Embodiments of the invention may provide[[s]], inter alia, a device in which a molded part decouples the carrier part and the bearing part from each other. For this purpose, the bearing part and the carrier part are arranged at a first distance from each other. In the assembled state, the first distance may extend along a normal to the outer surface of the bearing part and to the inner surface of the carrier part. The decoupling has the effect that tolerances in the manufacture of the components of the device can be compensated. Further, the transmission of vibrations from the intermediate shaft to the carrier part is reduced. The molded part is frictionally connected to the inner surface of the carrier part and the outer surface of the bearing part. This frictional connection can be produced by inserting the molded part between the carrier part and the bearing part. Specially designed surfaces for adhesion promoters on the molded part, the bearing part and the carrier part are not necessary for this purpose. The surfaces of the molded part, the outer surface of the bearing part and the inner surface of the carrier part can therefore be produced without any special requirements for adhesion promoters. The carrier part as well as the bearing part can be designed as a pure assembly part. This reduces the cost of vulcanization, in particular the cycle time is reduced, no adhesion promoter may be required, etc. As a result, the cost of the entire component may be reduced. Thus, embodiments of the invention provide a device for supporting an intermediate shaft which can be manufactured at low cost.

It is conceivable that the outer surface, the inner surface and/or the molded part may, for example, be of arcuate design, at least in certain areas.

The molded part may thus be provided as a ring which, in the assembled state, extends between the inner surface of the carrier part and the outer surface of the bearing part. Annular moldings can be produced without great effort.

It is further conceivable that the molded part may be made of an elastomer, for example.

Elastomer has good decoupling properties, in particular vibrations between the bearing part and the carrier part are damped. Impacts can also be at least partially absorbed by a molded part consisting of an elastomer.

According to one embodiment, it is conceivable that the molded part may have an inner connecting surface for connecting to the outer surface and an outer connecting surface for connecting to the inner surface, wherein the inner and outer connecting surfaces can be arranged at a second distance from one another in an unassembled state, the second distance being greater than the first distance.

In an assembled state, the outer surface and the inner surface may be spaced apart by the first distance. Since the molded part in the unassembled state may have the second distance between its connecting surfaces, the second distance being greater than the first distance, the molded part has a high overlap with the two parts, before it is inserted between the bearing part and the carrier part. The second distance may extend along a normal to the inner and outer connecting surfaces. When inserted between the bearing part and the carrier part, the molded part is deformed and the distance between the inner and outer connecting surfaces is reduced to the first distance. This causes a high contact force between the inner connecting surface of the molded part with the outer surface of the bearing part and between the outer connecting surface and the inner surface of the carrier part. This increases the friction of the frictional connection and improves the connection.

It is further conceivable that the molded part may be transferred from the unassembled state to an assembled state, in which the molded part is arranged between the carrier part and the bearing part, for example by pressing it in between the bearing part and the carrier part.

For this purpose, the molded part may be inserted parallel to the outer surface and the inner surface, for example. The force used to press in the molded part must be greater than the friction ocurring between the molded part and the inner and outer surfaces. The transfer of the molded part from the unassembled state to the assembled state by press-fitting simplifies the manufacture of the device.

In another embodiment, it is conceivable that the device may have an adhesion promoter for a postbonding process between the molded part and at least part of the inner surface and/or at least part of the outer surface.

After a frictional connection has initially been made, the molded part may thus be subsequently and additionally bonded to the outer surface and/or the inner surface using an adhesion promoter. This may be done, for example, by subsequent aging at high temperature. In this way, the bond between the molded part and the bearing part or the carrier part can be improved.

In another embodiment, the molded part may have at least one cut surface extending between the inner surface and the outer surface.

The molded part may thus be cut or cut to length from a larger piece of material, for example. In particular, if the molded part has an annular shape, the molded part can be cut from a tube. This can further simplify the manufacture of the device.

Further, the bearing part may have, for example, a cylindrical outer diameter or a sleeve element on which the circumferential outer surface is arranged.

The sleeve element may, for example, enclose a ball bearing. The ball bearing then has no direct contact with the molded part.

According to another example, it is conceivable that the carrier part may comprise at least one fastening device for connecting the device to an engine and/or an engine attachment.

For example, the fastening device may comprise at least one flange element having at least one opening.

Further, the bearing part may be, for example, a rolling bearing or a plain bearing.

It is further conceivable that the bearing part and/or the carrier part may, for example, comprise metal and/or plastic and/or composite material.

In combination with the frictional connection between the molded part, the bearing part and the carrier part, special machining of the material surfaces is avoided. The molded part, the bearing part and the carrier part can thus be manufactured at a lower cost.

Embodiments of the further relate[[s]] to a system comprising an intermediate shaft and a device according to the preceding description, wherein the intermediate shaft is connected to the bearing part and is rotatably supported in the bearing part.

Advantages and effects as well as further embodiments of the system result from the advantages and effects as well as further embodiments of the device described above. Reference is therefore made in this respect to the preceding description.

Further features, details and advantages of the invention result from the wording of the claims as well as from the following description of embodiments with reference to the drawings. The drawings show in:

### BRIEF DESCRIPTION OF THE DRAWINGS

FIG. 1 is a schematic representation of a vehicle with an embodiment of the device;

FIG. 2 is a schematic representation of an embodiment of the device;

FIG. 3 is a schematic representation of the individual components of an embodiment of the device; and

FIG. 4a, b is a schematic representation of an embodiment of the device in the unassembled state (a) and assembled state (b).

### DETAILED DESCRIPTION

In the following, the device for supporting an intermediate shaft, such as an intermediate shaft of a gearbox, is referenced in its entirety by the reference sign 10.

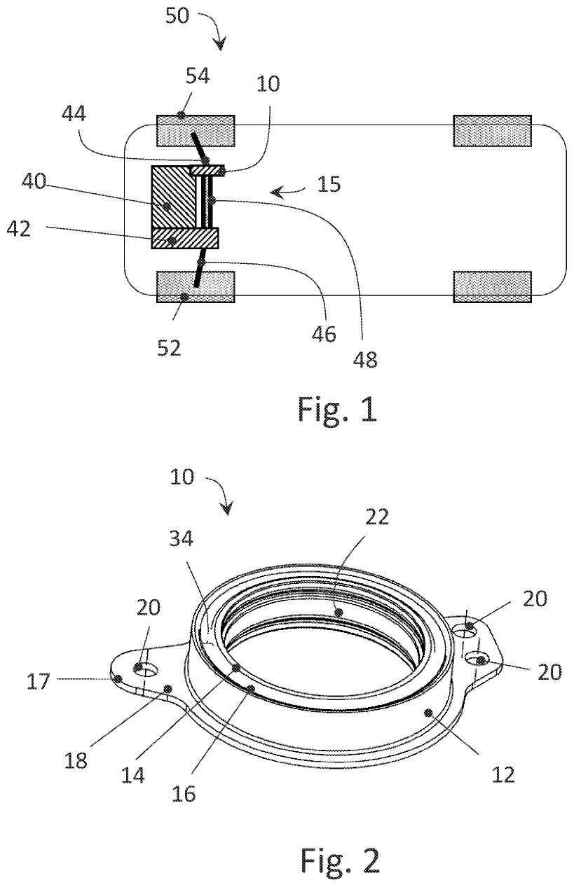

FIG. 1 schematically shows a vehicle 50 with an engine 40 which is connected to wheels 52, 54 via a gearbox 42. The gearbox 42 is arranged off-center and is located closer to the wheel 52 than to the wheel 54. The gearbox is connected to the wheel 52 via a side shaft 46.

The wheel 54 is connected to the gearbox 42 via an intermediate shaft 48 and another side shaft 44. The intermediate shaft 48 is mounted in the device 10 and attached to the engine 40. Alternatively or additionally, the device 10 may be attached to an engine attachment part or to further parts of the body.

The intermediate shaft 48 and the device 10 are combined to form a system 15. The intermediate shaft 48 is rotatably mounted in the device 10.

The device 10 is shown in more detail in FIG. 2. The device 10 comprises a carrier part 12, a bearing part 14 and a molded part 16. The molded part 16 is arranged between the carrier part 12 and the bearing part 14 and is connected to the carrier part 12 and the bearing part 14 via a frictional connection.

The distance between the bearing part 14 and the carrier part 12 is referred to as the first distance 34.

For connection to the engine 40 or the engine attachment part or the body, the carrier part 12 comprises a fastening device 17 which has a flange element 18 and at least one opening 20. A fastening element, for example a bolt with a latching hook, a screw, a nail or a rivet, etc., can be passed through the at least one opening 20 for connection to the engine 40 or the engine attachment part or the body.

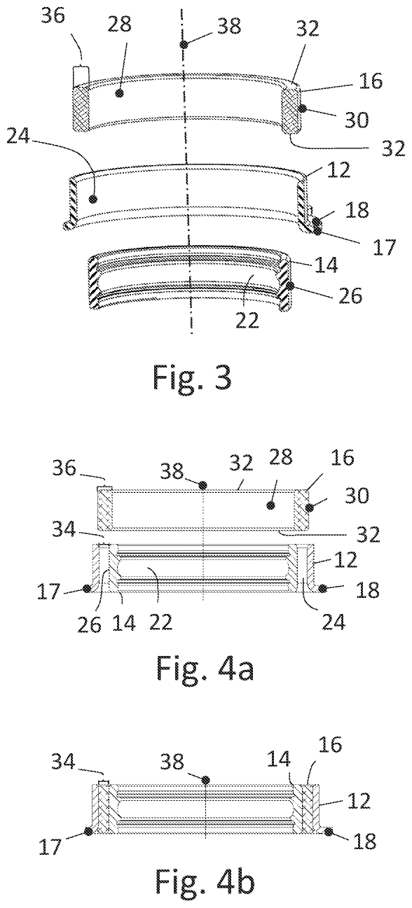

In FIG. 3, individual components of the device 10 are shown. The molded part 16, the carrier part 12 and the bearing part 14 are only half shown in FIG. 3 to provide a better overview.

The molded part 16 is annular in shape and consists of an elastomer. The molded part 16 can therefore be elastically deformed. Further, the material of the molded part 16 can be more easily deformed by heating.

Further, the molded part 16 has an inner connecting surface 28 and an outer connecting surface 30. The inner and outer connecting surfaces 28, 30 extend around a central axis 38 of the annular molded part 16, with the inner connecting surface 28 facing into the annulus and the outer connecting surface 30 facing out of the annulus. Further, the inner connecting surface 28 and the outer connecting surface 30 are arranged on two sides of the molded part 16 facing away from each other.

The distance between the inner bonding surface 28 and the outer bonding surface 30 is referred to as the second distance 36. The second distance 36 is greater than the first distance 34.

The molded part 16 may have been cut to length from a tube. Therefore, the molded part 16 may have cut surfaces 32 in the axial direction. The molded part may include cut surfaces 32 on two sides facing away from each other. Further, the cut surface 32 extends between the inner connection surface 28 and the outer connection surface 30. The at least one cut surface 32 may connect the inner connection surface 28 to the outer connection surface 30.

Optionally, the molded part 16 may include an adhesion promoter on the inner bonding surface 28 and/or on the outer bonding surface 30 for a postbonding process.

In this example, the carrier part 12 is also annular in shape and may comprise a plastic, a metal, or a composite material. Alternatively, the carrier part 12 may have another shape that includes an opening for receiving the molded part 16 and the bearing part 14. The carrier part 12 has a receptacle for a molded part 16 and a bearing part 14, which is bounded by an inner surface 24. The inner surface 24 faces a central axis 38 of the carrier part 12 and extends about said central axis 38. In this example, the inner surface 24 is annular in shape.

Optionally, the carrier part 12 may have an adhesion promoter on the inner surface 24 for a post-bonding process.

The bearing part 14 also has an annular shape and may also be made of a plastic, a metal, or a composite material. Alternatively, the bearing part 14 may have another shape that fits within the receptacle of the carrier part 12. It has an outer surface 26 that extends about and faces away from the central axis 38.

An intermediate shaft 48 may be rotatably mounted in the bearing part 14. For this purpose, the bearing part 14 may optionally be a rolling bearing or a plain bearing.

Alternatively, the bearing part 14 may optionally include a sleeve member having a receptacle 22 for a rolling bearing. In this alternative, the intermediate shaft 48 is rotatably mounted in the rolling bearing, which in turn is received in the receptacle 22 of the sleeve element of the bearing part 14.

Optionally, the bearing part 14 may have an adhesion promoter on the outer surface 26 for a post-bonding process.

The carrier part 12 and the bearing part 14 may be configured as assembly parts only.

Further, the molded part 16, the bearing part 14, and the carrier part 12 may be configured such that the molded part 16, the inner surface 24, and the outer surface 26 are arc-shaped only in sections. The molded part 16, the inner surface 24 and the outer surface 26 can therefore also be elliptical in shape, for example.

FIGS. 4a and 4b show the device 10 in various states.

FIG. 4a shows the unassembled state of the device 10. The bearing part 14 is inserted into the carrier part 12, with the outer surface 26 of the bearing part 14 facing the inner surface 24 of the carrier part. The carrier part 12 extends around the bearing part 14, and a gap is arranged between the outer side 26 and the inner side 24, the width of which corresponds to the first distance 34.

In FIG. 4a, it is further shown that the molded part 16 covers the bearing part 14 and the carrier 12 when it is arranged at the gap.

In FIG. 4b, the device is shown in the assembled state. The molded part 16 is arranged between the bearing part 14 and the carrier part 12. For arranging the molded part 16 between the bearing part 14 and the carrier part 12, the molded part 16 can be pressed into the gap, i.e. the molded part 16 can be transferred from the unassembled state to the assembled state by pressing in. Optionally, the molded part 16 can be heated for this purpose to increase the elasticity of the molded part 16. Furthermore, a lubricant can be used for the assembly, which reduces the friction between the molded part 16 and the bearing part 14 or the carrier part 12 during press-fitting.

During press-fitting, the molded part 16 is deformed as it extends in a radial direction with respect to the axis 38 in the unmounted state over the second distance 36, which is greater than the gap width corresponding to the first distance 34. The molded part 16 is arranged with the inner connecting surface 28 against the outer surface 26 of the bearing part 16 during press-fitting, and with the outer connecting surface 30 against the inner surface 24 of the carrier part 12.

The distance between the inner connecting surface 28 and the outer connecting surface 30 decreases to the first distance 34 during press-fitting.

Due to the elastic deformation of the molded part 16 during press-fitting, the material of the molded part presses the inner connecting surface 28 in a radial direction against the outer surface 28 and the outer connecting surface 30 in a radial direction against the outer surface 26. This causes a frictional connection between the molded part 16 and the bearing part 14 or the carrier part 12.

If a postbonding process is provided, the device 10 may undergo the postbonding process in the assembled state.

The invention is not limited to any of the above-described embodiments but may be varied in a variety of ways.

All the features and advantages, including constructional details, spatial arrangements, and procedural steps, which emerge from the claims, the description and the drawing, may be employed in the context of the disclosure both individually and in a wide variety of combinations.

1. A device for supporting an intermediate shaft of a gearbox, the device comprising:
at least one bearing part for supporting an intermediate shaft, the at least one bearing part having an outer surface with at least a section that is circumferential;
at least one carrier part having an inner surface extending around the outer surface at a first distance from the at least one bearing part; and
at least one molded part for decoupling the carrier part from the at least one bearing part, the at least one molded part disposed between the inner surface and the outer surface,
wherein the molded part is frictionally connected to the inner surface and the outer surface.

2. The device according to claim 1, wherein the outer surface, the inner surface, and/or the molded part are designed to be arcuate at least in regions thereof.

3. The device according to claim 1, wherein the molded part consists of an elastomer.

4. The device according to claim 1, characterized in that wherein the molded part has an inner connecting surface for connecting to the outer surface and an outer connecting surface for connecting to the inner surface, the inner connecting surface and the outer connecting surface are provided at a second distance from one another in an unassembled state, and the second distance is greater than the first distance.

5. The device according to claim 4, wherein the molded part is configured to be transferred from the unassembled state to an assembled state by pressing in the molded part between the bearing part and the carrier part, and, in the assembled state, the molded part is provided between the carrier part and the bearing part.

6. The device according to claim 1, wherein the device comprises an adhesion promoter for a postbonding process between the molded part and at least part of the inner surface and/or at least part of the outer surface.

7. The device according to claim 1, wherein the molded part has at least one cut surface extending between the inner surface and the outer surface.

8. The device according to claim 1, wherein the bearing part has a sleeve element, and the outer surface is provided on the sleeve element.

9. The device according to claim 1, wherein the carrier part has at least one fastening device for connecting the device to al engine and/or an engine attachment part.

10. The device according to claim 9, wherein the fastening device comprises at least one flange element with at least one opening.

11. The device according to claim 1, wherein the bearing part is a rolling bearing or a plain bearing.

12. The device according to claim 1, wherein the bearing part and/or the carrier part are made of metal and/or plastic and/or composite material.

13. A system comprising an intermediate shaft and a device according to claim 1, wherein the intermediate shaft is connected to the bearing part and is rotatably mounted in the bearing part.
